(19) United States
(12) Patent Application Publication
(10) Pub. No.: US 2007/0214333 A1
(43) Pub. Date: Sep. 13, 2007

(54) Modifying node descriptors to reflect memory migration in an information handling system with non-uniform memory access

(75) Inventors: Vijay B. Nijhawan, Austin, TX (US); Madhusudhan Rangarajan, Round Rock, TX (US); Allen Chester Wynn, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/372,569

(22) Filed: Mar. 10, 2006

(51) Int. Cl. G06F 13/00

(52) U.S. Cl. 711/165

(57) ABSTRACT

An information handling system includes a first node and a second node. Each node includes a processor and a local system memory. An interconnect between the first node and the second node enables a processor on the first node to access system memory on the second node. The system includes affinity information that is indicative of a proximity relationship between portions of system memory and the system nodes. A BIOS module migrates a block from one node to another, reloads BIOS-visible affinity tables, and reprograms memory address decoders before calling an operating system affinity module. The affinity module modifies the operating system visible affinity information. The operating system then has accurate affinity information with which to allocate processing threads so that a thread is allocated to a node where memory accesses issued by thread are local accesses.

### TECHNICAL FIELD

The present invention is related to the field of computer systems and more particularly non-uniform memory access computer systems.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a non-uniform memory access (NUMA) server. A NUMA server is implemented as a plurality of server “nodes” where each node includes one or more processors and system memory that is “local” to the node. The nodes are interconnected so that the system memory on one node is accessible to the processors on the other nodes. Processors are connected to their local memory by a local bus. Processors connect to remote system memories via the NUMA interconnect. The local bus is shorter and faster than the NUMA interconnect so that the access time associated with a processor access to local memory (a local access) is less than the access time associated with a processor access to remote memory (a remote access). In contrast, conventional Symmetric Multiprocessor (SMP) systems are characterized by substantially uniform access to any portion of system memory by any processor in the system.

NUMA systems are, in part, a recognition of the limited bandwidth of the local bus in an SMP system. The performance of an SMP system varies non-linearly with the number of processors. As a practical matter, the bandwidth limitations of the SMP local bus represent an insurmountable barrier to improved system performance after approximately four processors have been connected to the local bus. Many NUMA implementations use 2-processor or 4-processor SMP systems for each node with an NUMA interconnection between each pair of nodes to achieve improved system performance.

The non-uniform characteristics of NUMA servers represent an opportunity and/or challenge for NUMA server operating systems. The benefits of NUMA are best realized when the operating system is proficient at allocating tasks or threads to the node where the majority of memory access transactions will be local. NUMA performance is negatively impacted when a processor on one node is executing a thread in which remote memory access transactions are prevalent. This characteristic is embodied in a concept referred to as memory affinity. In a NUMA server, memory affinity refers to the relationship (e.g., local or remote) between portions of system memory and the server nodes.

Some NUMA implementations support, at one level, the concept of memory migration. Memory migration refers to the relocation of a portion of system memory. For example, a bank/card of memory can be hot plugged into an empty memory slot or as a replacement for an existing memory slot. After a new memory bank/card is installed, the server BIOS can copy or migrate the contents of any portion of memory to the new memory and reprogram address decoders accordingly. If, however, memory is migrated to a portion of system memory that resides on a node that is different than the node on which the original memory resided, performance problems may arise due to a change in memory affinity. Threads or processes that, before the memory migration event, were executing efficiently because the majority of their memory accesses were local may execute inefficiently after the memory migration event because the majority of their memory accesses have become remote.

### SUMMARY OF THE INVENTION

Therefore a need has arisen for a NUMA-type information handling system operable to dynamically adjust its memory affinity structure following a memory migration event.

The present disclosure describes a system and method for modifying memory affinity information in response to a memory migration event.

In one aspect, an information handling system, implemented in one embodiment as a non-uniform memory architecture (NUMA) server, includes a first node and a second node. Each node includes one or more processors and a local system memory accessible to its processor(s) via a local bus. A NUMA interconnect between the first node and the second node enables a processor on the first node to access the system memory on the second node.

The information handling system includes affinity information. The affinity information is indicative of a proximity relationship between portions of system memory and the nodes of the NUMA server. A memory migration module copies the contents of a block of memory cells from a first portion of memory on the first node to a second portion of memory on the second node. The migration module preferably also reassigns a first range of memory addresses from the first portion to the second portion. An affinity module detects a memory migration event and responds by modifying the affinity information to indicate the second node as being local to the range of memory addresses.

In another aspect, a disclosed computer program (software) product includes instructions for detecting a memory migration event which includes reassigning a first range of memory addresses from a first portion of memory that resides on a first node of the NUMA server to a second portion of memory on a second node of the server. The product further includes instructions for modifying the affinity information to reflect the first block of memory as being located on the second node of the server.

In yet another aspect, an embodiment of a method for maintaining an affinity structure in an information handling system as claimed includes modifying an affinity table storing data indicative of a node location of a corresponding portion of system memory following a memory migration event. An operating system is notified of the memory migration event. The operating system responds by updating operating system affinity information to reflect the updated affinity table.

The present disclosure includes a number of important technical advantages. One technical advantage is the ability to maintain affinity information in a NUMA server following a memory migration event that could alter affinity information and have a potentially negative performance effect. Additional advantages will be apparent to those of skill in the art and from the FIGURES, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a block diagram showing selected elements of a NUMA server;

FIG. 2 is a block diagram showing selected elements of a node of the NUMA server of FIG. 1;

FIG. 3 is a conceptual representation of a memory affinity data structure within a resource allocation table suitable for use with the NUMA server of FIG. 1;

FIG. 4 is a conceptual representation of a locality information table suitable for use with the NUMA server of FIG. 1;

FIG. 5 is a flow diagram illustrating selected elements of a method for dynamically maintaining memory/node affinity information in an information handling system, for example, the NUMA server of FIG. 1; and

FIG. 6 is a flow diagram illustrating additional detail of an implementation of the method depicted in FIG. 5.

### DETAILED DESCRIPTION OF THE INVENTION

Preferred embodiments of the invention and its advantages are best understood by reference to the drawings wherein like numbers refer to like and corresponding parts.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

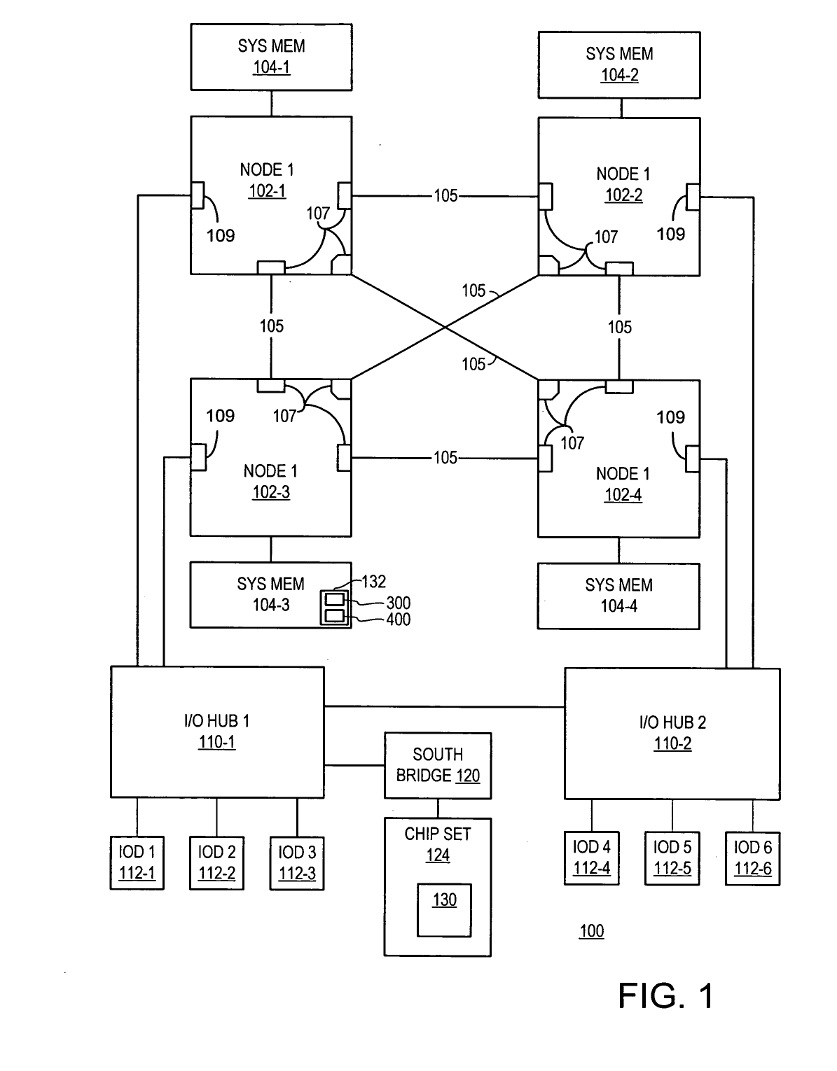

Preferred embodiments and their advantages are best understood by reference to FIG. 1 through FIG. 5, wherein like numbers are used to indicate like and corresponding parts. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In one aspect, a system and method suitable for modifying or otherwise maintaining processor/memory affinity information in an information handling system are disclosed. The system may be a NUMA server system having multiple nodes including a first node and a second node. Each node includes one or more processors and local system memory that is accessible to the node processors via a shared local bus. Processors on the first node can also access memory on the second node via an inter-node interconnect referred to herein as a NUMA interconnect.

The preferred implementation of the information handling system supports memory migration, in which the contents of a block of memory cells are copied from a first portion of memory to a second portion of memory. The memory migration may also include modifying memory address decoder hardware and/or firmware to re-map a first range of physical memory addresses from a first block of memory cells (i.e., a first portion of memory) to the second block of memory cells (i.e., a second portion of memory). If the first and second portions of memory reside on different nodes, the system also modifies an affinity table to reflect the first range of memory addresses, after remapping, as residing on or being local to the second node.

Following modification of the affinity table, the updated affinity information is used to re-populate operating system affinity information. Following re-population of the operating system affinity information, the operating system is able to allocate threads to processors in a node-efficient manner in which, for example, a thread that primarily accesses the range of memory addresses may be allocated, in the case of a new thread, or migrated, in the case of an existing thread, to a processor on the second node.

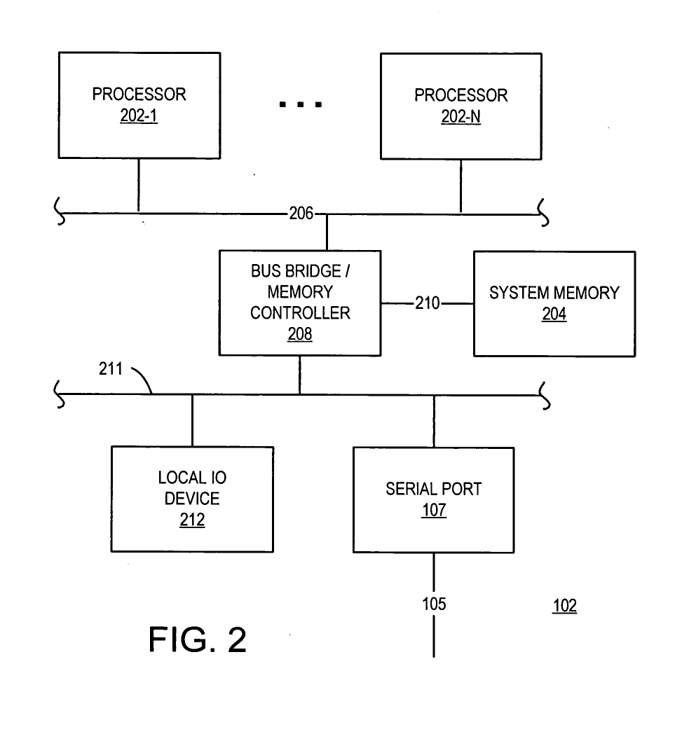

Turning now to FIG. 1, selected elements of an information handling system 100 suitable for implementing a dynamic affinity information modification method are depicted. As depicted in FIG. 1, information handling system 100 is implemented as a NUMA server, and information handling system 100 is also referred to herein as NUMA server 100. In the depicted implementation, NUMA server 100 includes four nodes 102-1 through 102-4 (generically or collectively referred to herein as node(s) 102). NUMA server 100 further includes system memory, which is distributed among the four nodes 102. More specifically, a first portion of system memory, identified by reference numeral 104-1, is local to node 102-1 while a second portion of system memory, identified by reference numeral 104-2, is local to second node 102-2. Similarly a third portion of system memory, identified by reference numeral 104-3, is local to third node 102-3 and a fourth portion of system memory, identified by reference numeral 104-4, is local to fourth node 102-4. For purposes of this disclosure, the term “local memory” refers to system memory that is connected to the processors of the corresponding node via a local bus as described in greater detail below with respect to FIG. 2.

Referring now to FIG. 2, selected elements of an implementation of an exemplary node 102 are presented. In the depicted implementation, node 102 includes one or more processors 202-1 through 202-n (generically or collectively referred to herein as processor(s) 202). Processors 202 are connected to a shared local bus 206. A bus bridge/memory controller 208 is connected to local bus 206 and provides an interface to a local system memory 204 via a memory bus 210. Bus bridge/memory controller 208 also provides an interface between local bus 206 and a peripheral bus 211. One or more local I/O devices 212 are connected to peripheral bus 211.

In the depicted implementation, a serial port 107 is also connected to peripheral bus 211 and provides an interface to an inter-node interconnect link 105, also referred to herein as NUMA interconnect link 105.

Returning now to FIG. 1, nodes 102 of NUMA server 100 are coupled to each other via NUMA interconnect links 105. The depicted implementation employs a NUMA interconnect link 105 between each node 102 so that each node 102 is directly connected to each of the other nodes 102 in NUMA server 100. For example, a first interconnect link 105-1 connects a port 107 of first node 102-1 to a port 107 on second node 102-2, a second interconnect link 105-2 connects a second port 107 of first node 102-1 to a corresponding node 107 of fourth node 102-4, and a third interconnect link 105-3 connects a third port 107 of first node 102-1 to a corresponding port 107 of third node 102-3. Other implementations of NUMA server 100 may include different NUMA interconnect architectures. For example, a NUMA server implementation that included substantially more nodes than the four nodes shown in FIG. 1 would likely not have sufficient ports 107 to accommodate direct NUMA interconnect links between each pair of nodes. In such cases, each node 102 may include a direct link to only a selected number of its nearest neighbor nodes. Implementations of this type are characterized by multiple levels of affinity (e.g., a first level of affinity associated with local memory accesses, a second level of affinity associated with remote accesses to nodes that are directly connected, a third level of affinity associated with remote accesses that traverse two interconnect links, and so forth). In other NUMA interconnect architectures, all or some of the nodes may connect to a switch (not depicted in FIG. 1) rather than connecting directly to another node 102. Regardless of the implementation of NUMA interconnect 105, each node 102 is preferably coupled, either directly or indirectly through an intermediate node, to every other node in the server.

First node 102-1 as shown in FIG. 1 has local access to first portion of system memory 104-1 through local bus 206 and memory bus 210 as shown in FIG. 2. Each node (e.g., node 102-1) in NUMA server 100 also has remote access to the system memory 104 residing on another node (e.g., node 102-2). First node 102-1 has remote access to the second portion of system memory 104-2 (which is local to second node 102-2) through NUMA interconnect link 105-1. Those familiar with NUMA server architecture will appreciate that, while each node preferably has access to the system memory of every other node, the access time associated with an access to local memory is less than the access time associated with an access to remote memory. Intelligent operating systems attempt to optimize NUMA server performance by allocating processing threads (referred to herein simply as threads) to a processor that resides on a node that is local with respect to most of the memory references issued by the thread.

NUMA server 100 as depicted in FIG. 1 further includes a pair of IO hubs 110-1 and 110-2. In the depicted implementation, first IO hub 110-1 is connected directly to first node 102-1 and third node 102-3 while second IO hub 110-2 is connected directly to second node 102-2 and fourth node 102-4. IO devices 112-1 through 112-3 are connected to first IO hub 110-1 while IO devices 112-4 through 112-6 are connected to second IO hub 110-2.

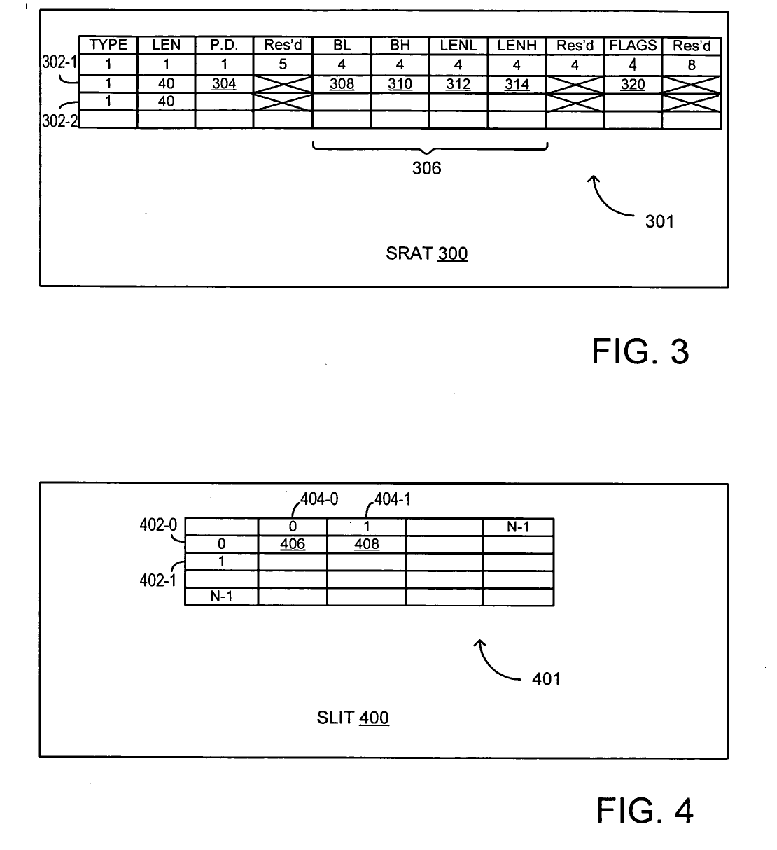

A chip set 124 is connected through a south bridge 120 to first IO hub 110-1. Chip set 124 includes a flash BIOS 130. Flash BIOS 130 includes persistent storage containing, among other things, system BIOS code that generates processor/memory affinity information 132. Processor/memory affinity information 132 includes, in some embodiments, a static resource affinity table 300 and a system locality information table 400 as described in greater detail below with respect to FIG. 3 and FIG. 4 and copies processor/memory affinity information 132 to a portion of system memory reserved for BIOS.

As used throughout this specification, affinity information refers to information indicating a proximity relationship between portions of system memory and nodes in a NUMA server. In one implementation, processor/memory affinity information is formatted in compliance with the Advanced Configuration and Power Interface (ACPI) standard. ACPI is an open industry specification that establishes industry standard interfaces for operating system directed configuration and power management on laptops, desktops, and servers. ACPI is fully described in the Advanced Configuration and Power Interface Specification revision 3.0a (the ACPI specification) from the Advanced Configuration and Power Interface work group (www.ACPI.info). The ACPI specification and all previous revisions thereof is incorporated in its entirety by reference herein.

ACPI includes, among other things, a specification of the manner in which memory affinity information is formatted. ACPI defines formats for two data structures that provide processor/memory affinity information. These data structures include a Static Resource Affinity Table (SRAT) and a System Locality Information Table (SLIT).

FIG. 3 depicts a conceptual representation of an SRAT 300, which includes a memory affinity data structure 301. Memory affinity data structure 301 includes a plurality of entries 302-1, 302-2, etc. (generically or collectively referred to herein as entry/entries 302). Each entry 302 includes values for various fields defined by the ACPI specification. More specifically, each entry 302 in memory affinity data structure 301 includes a value for a proximity domain field 304 and memory address range information 306. In the case of a multi-node NUMA server, the proximity domain field 304 contains a value that indicates the node on which the memory address range indicated by the memory address range information 306 is located. In the implementation depicted in FIG. 3, memory address range information 306 includes a base address low field 308, a base address high field 310, a low length field 312, and a high length field 314. Each of the fields 308 through 314 is a 4-byte field. The base address low field 308 and the base high field 310 together define a 64-bit base address for the relevant memory address range. The length fields 312 and 314 define a 64-bit memory address offset value that, when added to the base address, indicates the high end of the memory address range. Other implementations may define a memory address range differently (e.g., by indicating a base address and a high address explicitly)

Memory affinity data structure 301 as shown in FIG. 3 also includes a 4-byte field 320 that includes 32 bits of information suitable for describing characteristics of the corresponding memory address range. These characteristics include, but are not limited to, whether the corresponding memory address range is hot pluggable.

Referring now to FIG. 4, a conceptual representation of one embodiment of a SLIT 400 is depicted. In the depicted embodiment, SLIT 400 includes a matrix 401 having a plurality of rows 402 and an equal number of columns 404. Each row 402 and each column 404 correspond to an object of NUMA server 100. Under ACPI, the objects represented in SLIT matrix 401 include processors, memory controllers, and host bridges. Thus, the first row 402 may correspond to a particular processor in NUMA server 100. The first column 404 would necessarily correspond to the same processor. The values in SLIT matrix 401 represent the relative NUMA distance between the locality object corresponding to the row and the locality object corresponding to the column. Data points along the diagonal of SLIT 400 represent the distance between a locality object and itself. The ACPI specification arbitrarily assigns a value of 10 to these diagonal entries in SLIT matrix 401. The value 10 is sometimes referred to as the SMP distance. The values in all other entries of SLIT 400 represent the NUMA distance relative to the SMP distance. Thus, a value of 30 in SLIT 400 indicates that the NUMA distance between the corresponding pair of locality objects is approximately 3 times the SMP distance. The locality object information provided by SLIT 400 may be used by operating system software to facilitate efficient allocation of threads to processing resources.

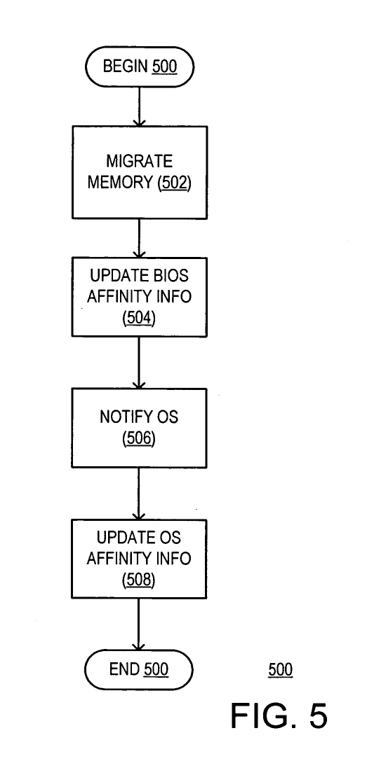

Some embodiments of a memory affinity information modification procedure may be implemented as a set of computer executable instructions (software). In these embodiments, the computer instructions are stored on a computer readable medium such as a system memory or a hard disk. When executed by a suitable processor, the instructions cause the computer to perform a memory affinity information modification procedure, an exemplary implantation of which is depicted in FIG. 5.

Turning now to FIG. 5, selected elements of an embodiment of a method 500 for maintaining affinity information in an information handling system are depicted. As depicted in FIG. 5, method 500 includes a memory migration block (block 502). In the depicted embodiment, memory migration triggers affinity update procedures because memory migration may include relocating one or more memory cells associated with particular physical memory addresses across node boundaries. In the absence of updating affinity information, memory migration may cause reduced performance when, following the migration, the operating system uses inaccurate affinity information as a basis for its resource allocations. Although the depicted implementation of affinity update method 500 is triggered by a memory migration event, other implementations may be triggered by any event that potentially alters the processor/memory affinity structure of the information handling system.

Following the memory migration event in block 502, method 500 as depicted includes updating (block 504) BIOS affinity information. The depicted embodiment of method 500 recognizes a distinction in affinity information that is visible to BIOS and affinity information that is visible to the operating system. This distinction is consistent with the reality of many affinity information implementations. As described previously with respect to FIG. 2, BIOS-visible affinity information may be stored in a dedicated portion of system memory. Operating system visible affinity information, in contrast, refers to affinity information that is stored in volatile system memory during execution. In conventional NUMA implementations, the affinity information is detected or determined by the BIOS at boot time and passed to the operating system. The conventional operating system implementation maintains the affinity information statically during the power tenure of the system (i.e., until power is reset or a reboot occurs). Method 500 as depicted in FIG. 5 includes a block for providing BIOS visible affinity information to the operating system following a memory migration event.

Thus, method 500 as depicted includes updating (block 504) the BIOS visible affinity information following the memory migration event. BIOS code then notifies (block 506) the operating system that a memory migration has occurred. Method 500 then further includes updating (block 508) the operating system affinity information (i.e., the affinity information that is visible to the operating system). Following the updating of the operating system visible affinity information, the operating system has accurate affinity information with which to allocate resources following a memory migration event.

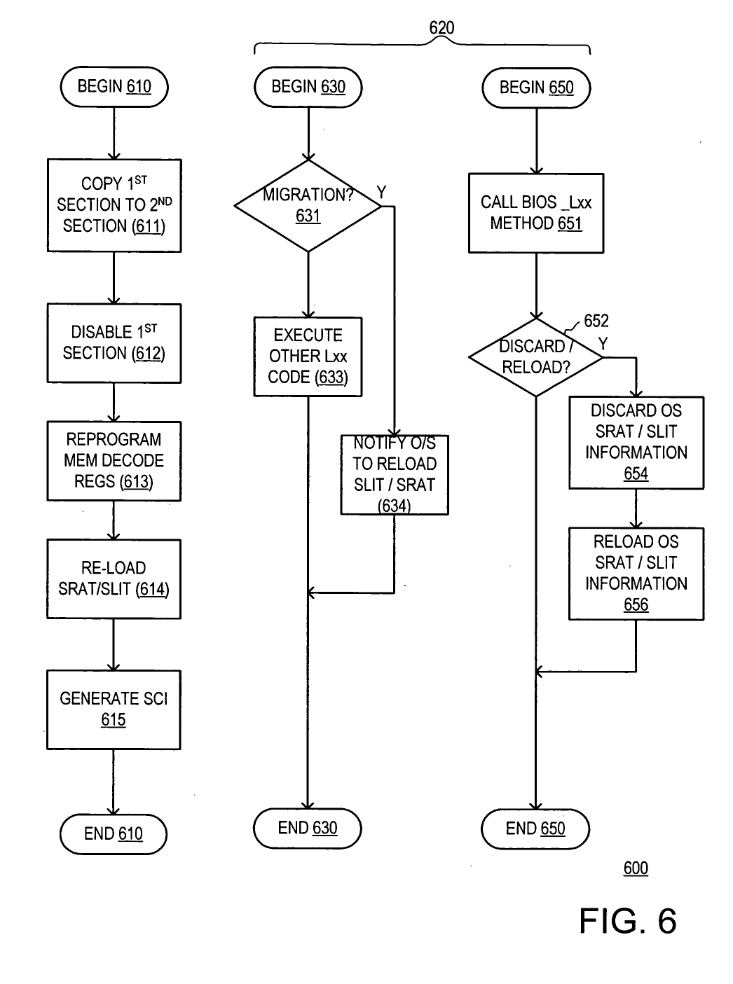

Turning now to FIG. 6, additional details of an implementation 600 of method 500 is depicted. In the depicted implementation, implementation 600 includes a system management interrupt (SMI) method 610, which may be referred to herein as memory migration module 610, a BIOS _Lxx method 630, and an operating system (OS) system control interrupt (SCI) method 650. The BIOS _Lxx method 630 and SCI method 650 may be collectively referred to herein as affinity module 620.

In one aspect, SMI 610 is a BIOS procedure for migrating memory and subsequently reloading memory/node affinity information. Memory migration refers to copying or otherwise moving the contents (data) of a portion of system memory from one portion of system memory to another and, in addition, altering the memory decoding structure so that the physical addresses associated with the data do not change. SMI 610 also includes updating affinity information after the memory migration is complete. Reloading the affinity information may include, for example, reloading SRAT 300 and SLIT 400.

As depicted in FIG. 5, SMI 610 includes copying (block 611) the contents or data stored in a first portion of memory (e.g., a first block of system memory cells) from the first section of memory to a second section of memory (e.g., a second block of system memory cells). The first portion of memory may reside on a different node than the second portion of memory. If so, memory migration may alter the memory affinity structure of NUMA server 100. In the absence of a technique for updating the affinity information it uses, NUMA server 100 may operate inefficiently after the migration completes because the server operating system will allocate threads based on affinity information that is inaccurate.

The depicted embodiment of migration module 610 includes disabling (block 612) the first portion of memory, which is the portion of memory from which the data was migrated. The illustrated embodiment is particularly suitable for applications in which memory migration is triggered in response to detecting a “bad” portion of memory. A bad portion of memory may be a memory card or other portion of memory containing one or more correctable errors (e.g., single bit errors). Other embodiments, however, may initiate memory migration even when no memory errors have occurred to achieve other objectives including, but not limited to, for example, distributing allocated system memory more evenly across the server nodes. Thus, in some implementations, memory migration will not necessarily include disabling portions of system memory.

As part of the memory migration procedure, the depicted embodiment of SMI 610 includes reprogramming (block 613) memory decode registers. Reprogramming the memory decoder registers causes a remapping of physical addresses from a first portion of memory to a second portion of memory. After memory decode register reprogramming, a physical memory address that accessed a memory location in a first portion of memory that was affected by the migration accesses a second memory cell location in a second portion of memory after the migration is complete and the memory addressed decoders have been reprogrammed.

Having reprogrammed the memory decoder registers in block 613, the depicted embodiment of SMI 610 includes reloading (block 614) BIOS-visible affinity information including, for example, SRAT 300 and SLIT 400 and/or other suitable affinity tables. As indicated previously, SRAT 300 and SLIT 400 are located, in one implementation, a portion of system memory reserved for or other accessible only to BIOS. SRAT 300 and SLIT 400 are sometimes referred to herein as the BIOS-visible affinity information to differentiate operating system memory affinity information, which is preferably stored in system memory.

In cases where memory migration crosses node boundaries, the BIOS visible affinity information (e.g., SRAT 300 and SLIT 400) after migration will be different than the SRAT and SLIT preceding migration. More specifically, the SRAT and SLIT after migration will reflect the migrated portion of memory as now residing on a new node. Method 600 as described further below includes making the modified BIOS-visible information visible to the operating system.

Following the re-loading of SRAT 300 and SLIT 400, the depicted embodiment of SMI 610 includes generating (block 615) a system control interrupt (SCI). The SCI generated in block 615 initiates procedures that expose the re-loaded BIOS-visible affinity information to the operating system. Specifically, as depicted the SCI interrupt generated in block 615 calls the operating system SCI handler 650.

OS SCI handler 650 is invoked when SMI 610 issues an interrupt. As depicted in FIG. 6, OS SCI handler 650 calls (block 651) a BIOS method referred to as a BIOS _Lxx method 630. An exemplary BIOS _Lxx method 630 is depicted in FIG. 5 as including a decision block 631 in which the _Lxx method determines whether a memory migration event has occurred. If a memory migration event has occurred, BIOS _Lxx method 630 includes notifying (block 634) the operating system to discard its affinity information, including its SRAT and SLIT information, and to reload a new set of SRAT and SLIT information. If _Lxx method 630 determines in block 631 that a memory migration event has not occurred, some other Lxx method is executed in block 633 and the BIOS _Lxx method 630 terminates. Thus, following completion of BIOS _Lxx method 630, the operating system has been informed of whether a memory migration event has occurred.

Returning back to OS SCI handler 650, a decision is made in block 652 whether to discard and reload the operating system affinity information. If BIOS _Lxx method 630 notified the operating system to discard and reload its memory affinity information, OS SCI handler 650 recognizes the notification, discards (block 654) its current affinity information, and reloads (block 656) the new information based on the new SRAT and SLIT values. The operating system affinity information may include tables, preferably stored in system memory, that mirror the BIOS affinity information including SRAT 300 and SLIT 400 stored in a BIOS reserved portion of system memory. If, on the other hand, OS SCI handler 650 has not been notified by BIOS _Lxx method 630 to discard and reload the SRAT and SLIT, OS SCI handler 650 terminates without taking further action. Thus, memory migration module 610 and affinity module 620 are effective in responding to a memory migration event by updating the affinity information maintained by the operating system.

Although the disclosed embodiments have been described in detail, it should be understood that various changes, substitutions and alterations can be made to the embodiments without departing from their spirit and scope

What is claimed is:

1. An information handling system, comprising:
a first node and a second node, wherein each node includes a processor and a local system memory accessible to the processor via a memory bus;
an interconnect between the first node and the second node enabling the processor on the first node to access the system memory on the second node;
an affinity table, stored in a computer readable medium, and indicative of node locations associated with selected portions of memory;
a memory migration module operable to copy contents of a first portion of memory on the first node to a second portion of memory on the second node and to reassign a first block of memory addresses from the first portion of memory to the second portion of memory;
an affinity module operable to detect a memory migration event and to respond to the memory migration event by updating affinity information to indicate the first block of memory addresses as being local to the second node.

2. The information handling system of claim 1, wherein the computer readable medium comprises a BIOS flash memory device.

3. The information handling system of claim 2, wherein the memory migration module further includes updating the affinity table.

4. The information handling system of claim 3, wherein the memory migration module further includes generating an operating system visible interrupt.

5. The information handling system of claim 4, wherein the affinity module includes an operating system portion configured to respond to the operating system interrupt by calling a BIOS routine that notifies the operating system to discard current affinity information and to reload new affinity information.

6. The information handling system of claim 5, wherein the affinity module responds to the notifying by discarding the current affinity information and reloading the new affinity information by accessing the updated affinity table.

7. The information handling system of claim 1, further comprising a locality table stored in the computer readable medium indicative of an access distance between selected system elements, wherein the memory migration module further includes updating the locality table and wherein the affinity module further includes updating locality information based on the updated affinity information.

8. A computer program product comprising instructions, stored on a computer readable medium, for maintaining an affinity structure in an information handling system, comprising:
responsive to a memory migration event, instructions for modifying an affinity table storing data indicative of a node location of a corresponding portion of system memory;
instructions for notifying an operating system of the memory migration event; and
responsive to said notifying, instructions for updating operating system affinity information to reflect said affinity table.

9. The computer program product of claim 8, further comprising, in response to said memory migration event, instructions for modifying locality table indicative of an access distance between processors and portions of system memory in said information handling system.

10. The computer program product of claim 9, wherein said instructions for modifying said affinity table and said locality table comprise BIOS instructions for modifying said affinity table and said locality table.

11. The computer program product of claim 10, wherein said BIOS instructions for modifying further includes BIOS instructions for issuing an operating system visible interrupt.

12. The computer program product of claim 11, further comprising operating system instructions, responsive to said interrupt, for calling a BIOS method, wherein said BIOS method includes instructions for notifying said operating system to reload operating system affinity and locality information.

13. The computer program product of claim 12, responsive to said notifying, instructions for said operating system reloading said operating system affinity and locality information.

14. The computer program product of claim 8, further comprising, instructions for reprogramming memory decode registers to reflect a of a block of memory addresses as being associated with a range of memory addresses.
responsive thereto, instructions for modifying the affinity information to reflect the first block of memory as being located on the second node.

15. A method for maintaining an affinity structure in an information handling system, comprising:
responsive to a memory migration event, modifying an affinity table storing data indicative of a node location of a corresponding portion of system memory;
notifying an operating system of the memory migration event; and
responsive to said notifying, updating operating system affinity information to reflect said affinity table.

16. The method of claim 15, further comprising, in response to said memory migration event, modifying locality table indicative of an access distance between processors and portions of system memory in said information handling system.

17. The method of claim 16, wherein modifying said affinity table and said locality table comprise a BIOS of said information handling system modifying said affinity table and said locality table.

18. The method of claim 17, wherein said modifying further includes said BIOS issuing an operating system visible interrupt.

19. The method of claim 18, further comprising an operating system, responsive to said interrupt, calling a BIOS method, wherein said BIOS method includes notifying said operating system to reload operating system affinity and locality information.

20. The method of claim 19, responsive to said notifying, said operating system reloading said operating system affinity and locality information.
